(19) United States
(12) Patent Application Publication
(10) Pub. No.: US 2008/0059590 A1
(43) Pub. Date: Mar. 6, 2008

(54) Method to filter electronic messages in a message processing system

(75) Inventors: Slavisa Sarafijanovic, Ecublens (CH); Jean-Yves Le Boudec, Jouxtens-Mezery (CH)

Correspondence Address: HARNESS, DICKEY & PIERCE, P.L.C., P.O. BOX 8910, RESTON, VA, 20195, US

(73) Assignee: Ecole Polytechnique Federale de Lausanne (EPFL)

(21) Appl. No.: 11/515,063

(22) Filed: Sep. 5, 2006

(51) Int. Cl. G06F 15/16; G06F 15/173

(52) U.S. Cl. 709/206; 709/223

(57) ABSTRACT

The present invention proposes a method to filter electronic messages in a message processing system, this message processing system comprising a temporary memory for storing the received messages intended to users, a first database dedicated to a specific recipient, and a second database dedicated to a group of recipients, this method comprising the steps of:

a) receiving an electronic message and storing it into the temporary memory,
b) generating a plurality of proportional signatures of said message, each signature being generated from predefined length of the message content at random location,
c) comparing with a first similarity threshold the generated signatures with the signatures present in the first database related to the message's recipient, and eliminating the generated signatures that are within the first similarity threshold of the first database's signatures, thus forming a set of suspicious signatures,
d) comparing with a second predefined similarity threshold the suspicious signatures with activated signatures present in the second database, and flagging the message as spam if at least one of the suspicious signatures is within the second predefined similarity threshold of the second database's activated signatures,
e) allowing a user to access the message, and moving said message from the temporary memory into a recipient's memory,
f) if the message is accepted by the user, storing the generated signatures related to this message into the first database related to this recipient,
g) if the message is declared spam by the user, using the suspicious signatures of said message in the second database for, either, if no similar signature exists, creating a non-activated signature into the second database with said signature or updating a previously stored signature that is within of a third similarity threshold of a suspicious signature by incrementing its first matching counter, and activating said previously stored signature if the matching counter is above a first counter threshold.

The proposed antispam system introduces two possibly advantageous novelties compared to the existing antispam solutions: 1) a representation of the email content designed for fundamentally better resistance to the spam obfuscations, and 2) processing of both the profiles of the users and implicit or explicit feedback from the users is integrated with collaborative spam-bulk information processing. Both the representation and processing are based on analogies to the human immune system.

### BACKGROUND ART

One of main problems not solved by the existing similarity-hashing based and other collaborative content filtering methods is that the representation of the email content used for antispam processing is vulnerable to the random or aimed text additions and other text obfuscations. Damiani at all., in their “An Open Digest-based Technique for Spam Detection” conference paper, investigate the vulnerability of a DCC-like representation and show the results that suggest that the representation becomes completely non-useful if enough random text is added buy the spammer, and that even much smaller, even 20 times smaller, amount of added text is needed by a spammer, if he knows the hashing function used by the filters, to achieve the same effect. Actually, the authors comment the results only in region of small random additions for which the representation is still good, i.e. the additions being up to 3 times longer then the spammy message, which was misinterpreted by many people who cited this work as proof of the representation's strength. Nothing prevents the spammer to add more text and move into the region where the representation doesn't work well, which could happen already with having the added random text 5 times longer then the spammy message. The problem here is that the signature is computed from all or predefined but variable in length parts of the email, which always gives enough room to the spammer for effective random text additions, and which our solution avoids.

Additionally, the known proposed or implemented collaborative content filtering solutions use the same and globally known hashing function among all the collaborating systems, which enables the spammers to apply so called aimed attack [Damiani at all], which is highly efficient in obfuscating the spam messages. For overcoming the aimed attacks, Damiani at all propose use of multiple hash functions, which makes the system more resistant to the aimed addition obfuscations, but still not enough resistant to prevent the spammer to add enough text for the attack to work. Our solution is more resistant to the aimed addition attack due to few novelties in the representation of the email content. Also the used architecture and representation together make it feasible to use different and not unrevealed to others hashing per antispam system (different systems could use the same hashing method but with a different randomly chosen parameter that makes the mapping different at different antispam systems) still being able to efficiently exchange the signatures.

The existing collaborative filtering methods also do not use randomization when computing signatures which makes the signatures computed from a known email fully predictable by the spammer and our system does. This is the problem because the spammer can know exactly the signatures that will be computed from the email received by a protected antispam system, and so can better tune the obfuscation to spoil the filter.

The general idea of exchanging the signatures derived from the emails for spam bulk detection is already patented. Cotten [U.S. Pat. No. 6,330,590] patents general idea for bulk detection by comparing different emails or their signatures, but doesn't address the above problems. We do not find a proposal that uses collaborative signatures based filtering and successfully address the above explained obfuscation problems, and the same holds for the implemented and deployed existing solutions (DCC for example). Our system addresses the above problems much more properly.

Regarding user of artificial immune system algorithms for spam filtering, there exists few proposals, but we find that both the used representation and the algorithms are crucially different then in our solution. Terri Oda and Tony White use words based representation which is sensitive to the obfuscations, and they also compute scores based on both good and bad words present in the email, which is, the same as Bayesian filtering methods, vulnerable to the additions of good words or phrases. Our design is different and overcome both the obfuscations and good words additions problems.

The representation used by Secker, Freitas and Timmis, another artificial immune systems based approach, is also words based and not resistant to the letters level obfuscations as the exact matching is used. As their method takes into the account bulk evidence per user bases, using accumulated emails of one user as the training set, it discovers the repeated spam patterns, but it is not good at finding ongoing spam bulk. Also as they use a feedback from the user mechanism on the level of complete email (they do not negatively select good patterns), repeated good patterns may also become the detectors and block good emails. Their system also assumes the user inspects the junk email, which is an undesirable filter feature. Our system overcomes all the four above listed limits of their system, by using crucially different representation and algorithms.

Another type of content-based filtering is Bayesian filtering, originally proposed by Paul Graham. A good feature of Bayesian filters is that they adapt to the protected user's profile, as they are trained on the good and bad email examples of the protected user. The disadvantages are vulnerability to the additions of good words attack and not taking into account the bulkiness of new spam.

Usually the Bayesian filtering and collaborative filtering is done separately, and then the results are combined, along with results from other methods, for the final decision making. It might be advantageous for collaborative filtering if some local spamminess processing is done before the information is exchanged for the collaborative filtering, which the existing systems do not take into the account and our system does.

The only known to us solution that uses the signatures on the strings of fixed length is the work by Feng at all, a peer to peer system for spam filtering, but their signatures are exact and not similarity signatures, as required by the rest of their system to work. It is very easy for the spammer to obfuscate email and prevent the detection by their system. Their analysis results in a different conclusion because they use completely unrealistic obfuscation to test their solution.

### SUMMARY OF THE INVENTION

The antispam system is designed using some analogies to the workings of the human immune system. It consists of the adaptive part for collaborative email content processing to discover spammy patterns within emails, and the innate part used to control the workings of the adaptive part. The system is added to an email server and protects its users, and preferably but not necessarily is connected to few other such systems.

The adaptive part produces so called detectors that are able to recognize spammy patterns within both usual and heavily obfuscated spam emails. This is made possible by processing emails on the level of so called “proportional signatures”: the text strings of the predefined length are sampled at random positions from the emails, and further transformed into the binary strings using our custom similarity preserving hashing, which enables both good differentiation of the represented patterns and their easy and robust similarity comparison.

Predefined samples length is crucial for the robustness of the used representation to the obfuscations. Similar principle is used in the human immune system when the peptides (protein chains) of approximately the same length are sampled from the viruses and presented on the surface of the cell for further processing.

Apart from applying the similarity hashing on the strings of the fixed length, we introduce a novel method based on the Bloom filter working principle to design the signature length and to set the bits of the signature, which disables the spammer from deleting some bits of the proportional signature that correspond to the spammy text by aimed addition of the text that sets up other bits add the expense of the spammy once, the feature that is not achieved by DCC and similar hashing schemes.

The adaptive processing looks at the bulkiness of the proportional signatures and at the same time takes into account the users' profiles and feedbacks from standard users' actions, using efficiently maximum of the available information for this so called collaborative content processing.

The profile of the user is taken into account by excluding from further processing the proportional signatures that show similarity to the examples of good signatures created from the good emails received or sent by the user. Similar “processing” exist in the human immune system, and is called negative selection. Then the local processing is done on the remaining signatures, the processing that takes together into the account their local bulkiness and the feedback from the users deleting their emails as spam, and based on the results some of the signatures my be decided to be exchanged with other collaborating systems. We assume that some of the users have and use the “delete as spam” button when they read their email, tough the system may work even if the assumption is released. Similar so called “danger signal” feedback exists in the human immune system when there is damage to the body's cells, and is used similarly as in this system, to help activating the detection.

For creating and activating the detectors, apart from the above explained evidence, the signatures obtained from other antispam systems are also accounted when evaluating the bulkiness. Similar clustering of the chemical matches on surface of the virus infected cell happens

Thanks to the combination of the used representation and the local processing, many good parts of the emails are excluded from further processing and the exchange with other collaborating systems, which enables the bad parts to be represented more precisely and better validated locally before they are exchanged. This increases the chances for the bad patterns to form a bulk and so create a detector, as they can't be easily hidden by the spammer within the added obfuscation text, as it is the case with the classical collaborative filtering schemes.

Local clustering of the signatures makes so called recurrent detection feasible, i.e. the new emails are checked upon arrival, but also a cheap additional checking is done upon creation of new active detectors during the pending time of the email, which further decreases non-detection of spam.

The randomness in sampling, and user profile and actions specific processing provide unpredictability and diversity of the produced detectors. The hashing is antispam system specific and publicly unknown, and yet the collaboration with other antispam systems is possible and feasible. This provides additional detectors diversity. Also, having the spammer doesn't know the hashing makes his attacks additionally difficult.

The first goal of the innate part is to protect some emails from further processing by the adaptive part, for example by authenticating the emails coming from known contacts. This may greatly decrease the load on adaptive part, as for example many emails could be protected because the majority of the communication is from already known contacts. The second goal of the innate part is to initiate some additional adaptive processing mechanisms, for example if some predefined rule such is the presence of predefined bad patterns is satisfied, which would help decrease the non-detection of spam.

### BRIEF DESCRIPTION OF THE DRAWINGS

The invention will be better understood thanks to the attached Figures in which:

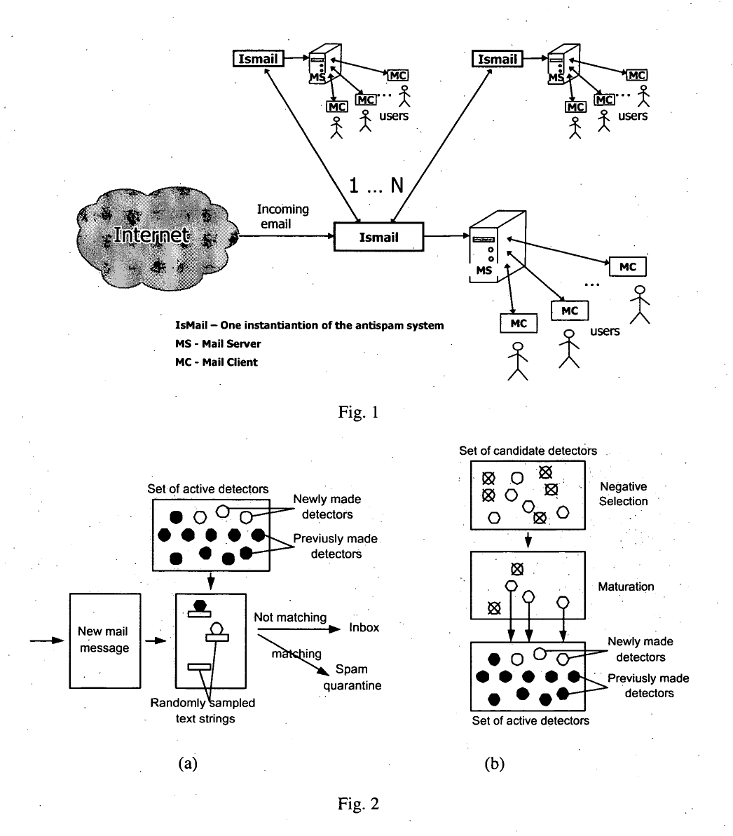

the FIG. 1 shows where do we put and how do we interconnect our antispam system,

the FIG. 2 represents a simplified explanation of the processes of detection and the detectors creation,

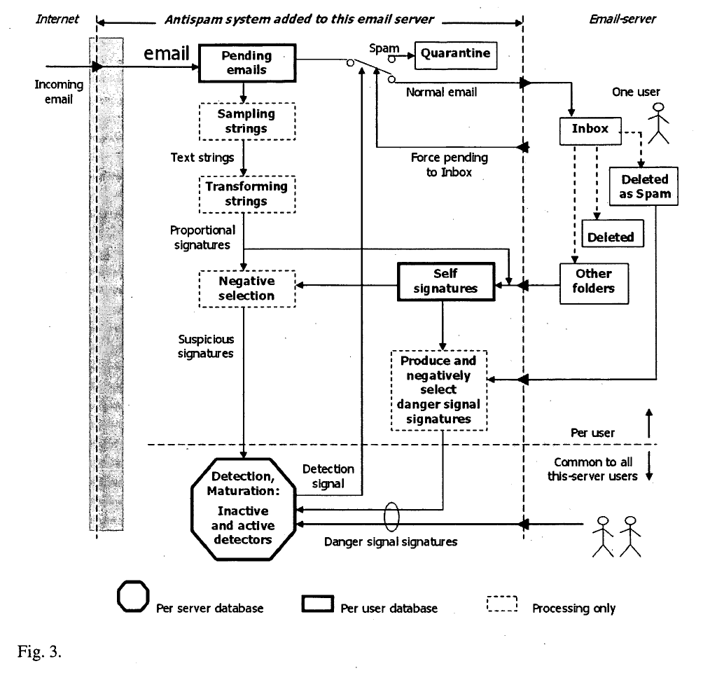

the FIG. 3 shows the processing-steps and databases block scheme of the system containing the steps of claim 1,

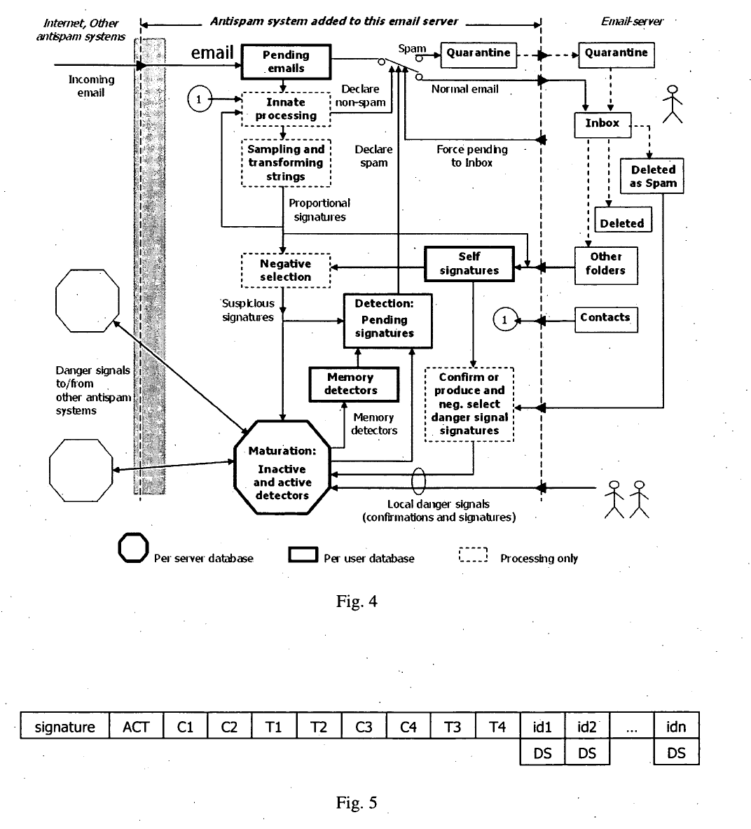

the FIG. 4 shows the processing-steps and databases block scheme of the system containing the steps of all the claims,

the FIG. 5 shows a possible syntax of inactive and active detectors,

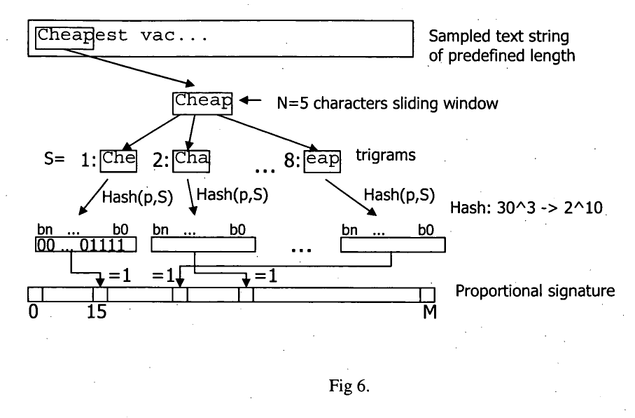

the FIG. 6 shows a possible similarity-hashing transformation of the text string into a binary representation called proportional signature,

### DETAILED DESCRIPTION OF THE INVENTION

### 1 Where do We Put the Antispam System

The antispam system, which filters the incoming e-mails for the users having their accounts on the same e-mail server, is placed in front of that e-mail server towards its connection to the Internet (FIG. 1). This is the logical place of the filter, though the deployment details might differ a bit. For example, with Postfix email server, the antispam system would be interfaced to the Procmail service that comes together with the Postfix software and is technically not in front of the email server, but in front of the space for storing emails.

The antispam system designated to one e-mail server and its users can be an application added to the e-mail server machine, or it can be a computer appliance running such an application. A few such antispam systems can collaborate with each other, and each of them is also interfaced to the accounts it protects on the e-mail server it protects. The collaboration to other antispam systems can be trusted, like in the case of few antispam systems administered by the same authority, or evaluated by the antispam system and correspondingly adapted, as it would probably be the case in a self-organized collaboration of antispam systems with no inherent mutual trust.

### 2 What the System Does, Inputs, Outputs.

The antispam system decides for the incoming emails whether they are spam or not. If enough evidence is collected that an e-mail is spam, it is either blocked or marked as spam and sent to the e-mail server for easy sorting into an appropriate folder. Otherwise, upon a maximum allowed delay by the antispam system or upon a periodic or user triggered send/receive request from the user's email client to the email server (the last can be considered as an option with virtually zero delay), the email is passed unchanged to the e-mail server.

The first-type inputs into the antispam system are incoming e-mail messages, before they are passed to the e-mail server.

The second-type inputs to an antispam system come from the access by the antispam system to the users' accounts it protects. The antispam system observes the following email-account information and events for each protected email account: text of the e-mails that the user sends; text of the e-mails that the user receives and does an action on them; the actions on the e-mails processed by the antispam system and received by the user, i.e. not filtered as spam, including deleting a message, deleting a message as spam, moving a message to a folder; the actions on the e-mails processed by the antispam system and filtered as spam, which could happen very rarely or never depending on the user's behavior and performances of the antispam system; the send/receive request from the email client of the user to the e-mail server; email addresses from user's contacts. We assume that some of the users protected by the antispam system have “delete” and “delete-as-spam” options available from its e-mail client for deleting messages and use them according to their wish, but this assumption could be realized and another feedback could be incorporated from the users actions on his emails, like moving the emails to good folder for example or simply deleting the emails. Here “delete” means move to “deleted messages” folder, “delete-as-spam” means move to “spam messages” folder. We also assume that all the e-mails that the user still did not permanently delete are preferably on the e-mail server, so the antispam system can observe the actions taken on them. Here “permanently delete” means remove from the e-mail account. The messages could be all moved to and manipulated only on the e-mail client, but then the client should enable all the actions on the e-mails to be observed by the antispam system.

The third-type inputs to the antispam system are messages coming from collaborating antispam systems. The messages contain useful information derived from the strings sampled from some of the e-mails that have been either deleted-as-spam by the users having accounts on the collaborating antispam systems or found by local processing as being suspicious to belong to a spam email. The third-type inputs to the antispam system are especially useful if there is small number of the accounts protected by the system. One of the factors that determine the performances of an antispam system is the total number of the active accounts protected by the antispam system and its collaborating systems.

The main outputs from the antispam system are based on the decisions for the incoming emails whether they are spam or not. If enough evidence is collected that an e-mail is spam, it is either blocked or marked as spam and sent to the e-mail server for easy sorting into an appropriate folder. Otherwise, upon a maximum allowed delay by the antispam system or upon a periodic or user triggered send/receive request from the user's email client to the email server (the last can be considered as an option with virtually zero delay), it is passed unchanged to the e-mail server.

Other outputs of the antispam system are the collaborating messages sent to other antispam systems that contain useful information derived from the strings sampled from some of the e-mails that has been deleted-as-spam by the users having accounts on the antispam system. If the collaboration is self-organized and based on evaluated and proportional information exchange, the antispam system has to create these outgoing collaborating messages in order to get similar input from other antispam systems.

### 3 How the System Does its Job—A Simplified High Level Explanation

In order to detect spam, the system produces and uses so-called detectors—the binary strings that are able to match incoming spam without hurting normal emails. Omitting the details, the use of the detectors is illustrated on the FIG. 2(a). Text strings of predefined length are sampled at random positions from a new email, processed into binary strings, and exposed to the previously and newly built detectors. If there is matching, the mail is quarantined as spam, otherwise it goes into the inbox.

The detectors are produced as illustrated on the FIG. 2(b). New candidate detectors are produced to match well randomly sampled strings from a new coming e-mail, disregarding whether it is spam or not. Negative selection is used to delete those candidates that match strings from the e-mails that a user has read before and didn't delete or mark as spam. The detectors that survive the negative selection have to maturate before they are empowered to block e-mails and put into the pool of active detectors. In maturation process the detectors have to prove that they are good at detecting patterns from e-mails that has strong indication to be spam. This indication comes from: (a) user's past mails deleted as spam, and (b) collaborative “ongoing spam bulk” evidence finding. A custom, immune system inspired, distributed algorithm is used to exchange and process the information in collaboration with other antispam systems.

### 4 How the System Does its Job—Internal Architecture and Processing Steps

Internal architecture and processing steps of the antispam system are shown on FIG. 4. Each block represents a processing step and/or a memory storage (database). All the shown blocks are per user and are shown for only one user on the figure, except the “Maturation” block which is common for all the users of the antispam system. The following processing tasks are done by the system.

Incoming emails are put into the pending state by the antispam system, until the detection process decides if they are spam or not, or until they are forced to inbox by pending timeout, or by periodic request from the mail client, or by a request from the user. The innate processing block might declare an email as non-spam and protect it from further processing by the system. If an email is found to be spam, it is quarantined by the antispam system or it is marked as spam and forwarded to the email server for an easy classification. Otherwise it is forwarded to the email server and goes directly to the Inbox. The user has access to the quarantined emails and can force some of them to be forwarded to the Inbox.

A pending email that is not protected by the innate part is processed in the following way. First, the text strings are sampled from the mail text using our randomized algorithm explained in detail later. Then, each sampled text string is converted into the binary-string representation form called proportionally signature. Each proportional signature is passed to the negative selection block. Another input to the negative selection block are so called self signatures, the signatures obtained in the same way as the proportional signatures of the considered incoming email, but with the important difference that they are sampled from the e-mails that the user implicitly declared as non-spam (by not explicitly deleting them as spam and sorting them in a non-spam folder, for example). In the negative selection block, the proportional signatures of the considered incoming email that are within a predefined negative selection specific similarity threshold of any self signature are deleted, and those that survive become so called suspicious signatures.

Each suspicious signature is duplicated. One copy of it is passed to the maturation block, and another to the detection block. Each suspicious signature passed to the detection block is stored there as pending signatures and compared against already existing memory and active detectors and against the new active and memory detectors potentially made during the email pending time. If a suspicious signature is matched (found to be within a predefined detection specific similarity threshold) by an active or memory detector, the corresponding email is declared as spam. Optionally, one matching doesn't cause the detection, but the detection block further processes the matching results between the detectors and suspicious signatures, and if it finds enough evidence it declares the corresponding email as spam. Pending signatures contain a pointer to the originating message vice versa, and they are kept until the message is pending.

The active detectors used in the detection process are produced by the maturation (block) process. The inputs to this process are the above mentioned suspicious signatures, local danger signatures and remote danger signatures. The local danger signal signatures are created in the same way like the suspicious signatures, but from the emails being deleted as spam by users protected by the antispam system. The remote signatures are obtained from collaborating antispam systems, if any, as explained later. Except upon start of the system, when the maturation block is empty, the maturation block contains so called inactive and active detectors. When a new suspicious signature is passed to the maturation block, it is compared using a first maturation similarity threshold against the signatures of the existing inactive detectors in the maturation block. If it is not matching any of the existing inactive detectors signatures, it is added as new inactive detector to the maturation block. If it is matching an existing inactive detector, the status of that detector (the first that matched) is updated, by incrementing its counter C1, refreshing its time field value T1, and adding the id of that user.

The same happens when a local danger signature is passed to the maturation block, the only difference is that, if matching, C2 and T2 are affected instead of C1 and T1 and DS bit is set to 1. Upon refreshing, the T2 is typically set to a much later expiration time then it is the case with T1. The same happens when a remote danger signature is received from a collaborating system, with a difference that id and DS are not added and the affected fields are only C3, C4, T3, T4. Local suspicious and danger signatures are passed to the maturation block accompanied by id value, and remote danger signatures do not have the id value but have its own C3 and C4 fields set to binary or real number values, so the local C3 and C4 counters may be incremented by one or by values dependant on these remote incoming signature counters.

Possible efficient inactive/active detector syntax is shown on the FIG. 5. ACT stands activated/non-activated bit and shows the state of the detector. C1 is counter of clustered local suspicious signatures. C2 is counter of clustered local danger signal signatures, i.e. signatures generated from emails deleted as spam by users and negatively selected against user specific self signatures. Ti is time field for validity date of counter Ci. idx is local (server wide) identification of the protected user account of a local clustered signature. DS is so called danger signal bit of a local clustered signature, and is set to 1 if its corresponding signature comes from deleted as spam, if set to 0 the signature a suspicious one.

Whenever an inactive detector is updated, a function that takes as input the counters of this detector is called that decide about a possible activation of the detector. If the detector is activated, it is used for checking the pending signatures of all the local users detection blocks (1 per user). We call this recurrent detection. Optionally, only the detection blocks are checked for which id is added to the detector. Optionally, the pending messages identifiers are added along with the id to the detector whenever the detector is updated, in order to make the process of the detection faster at the price of the small additional state keeping.

Upon the activation of a detector, its signature is copied to the memory detectors databases of those users that had their id added to the detector and appropriate DS bit set to 1. Memory detectors are also assigned a life time, and this time is longer then for the activated detectors.

Whenever a new detector is added or an existing is updated by the local suspicious or danger signature, a function is called that takes as inputs C1 and C2 and decides if a signature should be sent to a collaborating system(s).

Both the inactive and active detectors live until all the lifetimes (T1-T4) are expired.

The old proportional signatures and detectors in different blocks are eventually deleted, either because of expired life time or need to make space for those newly created.

The FIG. 3: The block scheme of the antispam system configuration covered in the claim 1. It shows local processing with creation of so called proportional signatures, use of the negative selection to create suspicious signatures, use of the “delete as spam” feedback from the users to create the detectors from the bulky suspicious signatures of the emails deleted as spam, and detection of the emails whose suspicious signatures upon their creation match the detectors

### 5 Possible Implementations of Some of the Processing Steps, and Some Possible Improvements and Additions to the System

It should be understood that the following are possible implementations of some processing steps, and proposed improvements to the system explained in the claims and the previous part of the document, but not the necessary way to implement the system and thus not decreasing its generality achieved in the claims and the description in the previous part of the document.

### 5.1 Sampling the Strings from Emails.

Sampling the text strings from an email received by the antispam system is the first step in representing the email content in a form used for its further processing by the antispam system. The following items explain a possible sampling in detail:

### 5.1.1 Sampling from the Email Body and Subject Line

The reason to sample from these two email parts is that the message that the sender passes to the recipient is fully contained in them. Here, the body of the email includes both the main text and the attachments. We emphasize that the sampled strings are processed by the adaptive part of the antispam system, and that the adaptive part looks at the “similarity” of the message strings to the strings from other messages that has been declared as spam or not spam. The header fields other than the subject line have special determined meanings, and they are not used for sampling and processing by the adaptive part of the antispam system, but they are processed by a set of rules that can be understood as the innate part of the antispam system.

### 5.1.2 Determining the Part of the Email Body to be Sampled.

If the email contains a large amount of text in the email body, sampling all the text would cause a high processing load on the antispam system, and could be exploited by the spammer for a denial-of-service attack. To avoid this problem, the antispam system uses a preprocessing method to select the only part of the incoming email body that is important to be processed, and it is the part that is most likely to be presented to the reader by his email reading program in the first opened window. Usually, based on this information the reader determines if the email is useful for him or if it is spam. The antispam system samples and processes the same relevant information. Apart from preventing from the denial-of-service attacks, this saves the resources of the antispam system while processing normal emails, and also makes the system more resistant against added text aimed at fooling the antispam system by masking the main message that might be spam by guessed “good text”. The exception are outgoing emails, that are sampled either on all the body or on its limited part, but the limit here is bigger than what is likely to be presented in an reading window. These are assumed to be normal emails, unless they are outgoing forwarded emails. The outgoing forwarded emails might often not be good examples of normal email, and are not sampled at all, if they are detected by the “Fwd” or “Fw” string in the subject line or a similar rule.

Any method which estimates the part of the email body that will fit in one window shown to the reader upon opening the message can be used to determine the part of the email that will be sampled. For example, a simple method would be the one that counts number of text characters and also takes into account the special formatting characters such as “new line” and “tab”. If email is in hypertext format, the method should take into the account the size of the letters and the size of the figures attached within the text. In a special case with many large figures in the beginning and with a little or no text, more space might be included for sampling, in order to capture some text that might follow the figures.

### 5.1.3 Sampling Takes into Account how the Message is Perceived by the User.

Unique feature of our sampling method is that it is designed with the goal to capture the information from the message similarly as it is perceived by a human reader. The idea behind this is that the antispam system should with high probability intercept and processes any textual message easily spotted by the human reader on the displayed email, even if the message is obfuscated by the spammer and hidden from simple sequential text parsing. Additionally, the sampling should be resource-consumption feasible and adaptive. The sampling should also process the attached figures that might be mixed with text in different ways.

For example this can be achieved through: 1) robust main sampling by sequential parsing of the text on the level of expressions and phrases, and 2) additional sampling triggered by the innate rules when the hypertext is found to have special structure in which included figures, colors, font, capitalization, or two-dimensional relative positions of the letters could cause the email to be perceived differently by the user then in the case of simple left-to-right character by character reading.

### 5.1.4 Sampling on the Level of Expressions and Phrases.

In the case of plain text message the reader's brain identifies the words grouped into short expressions or into phrases or sentences in order to grab meaningful information from the text. Using a deterministic algorithm to find the borders between the words and between the sentences or phrases, in order to decide the sampling units, would be easily tricked by the spammer knowing the algorithm. To avoid vulnerability to such spammers' tricks, the antispam system uses a probabilistic approach: it samples the text at pseudo-random positions, using the two possible sample sizes. One sample size is designed to have good chance to overlap well with short expressions; another is designed to overlap well with phrases. Fixed sample sizes are important as they enable the antispam system to efficiently compute significant statistical similarity among the samples from different messages, which, when accompanied with appropriate artificial immune system algorithms, enable a very robust identification of the patterns in the email that are related to the patterns in other emails sent to and/or experienced by the user or by the users of collaborating antispam systems.

### 5.1.5 Sampling Algorithm.

Let L1 be the size of the long samples, the samples that are designed to capture the phrases. Let L2 be the size of the short samples, the samples that are designed to capture the expressions. These parameters must be equal within one group of the collaborating antispam systems, but might differ among the different groups.

The sampling is done in the following way. The subject line and the email textual part that are determined to be sampled are first concatenated and considered one text block. Let pf(i) be the index within the text block of the first character of the i-th sample, pl(i) the index within the text block of the last character of the i-th sample, L the size of the text block, Fs the positive fixed advancing step from pf(i) to pf(i+1) for the samples of size Ls, As the average additional advancing step from pf(i) to pf(i+1) for the samples of size Ls, RandU(k,l) a random integer sampled uniformly on the segment [k,l]. The algorithm for sampling the Ls-sized samples is:

```
pf(1,s)=1, pl(1,s)= min{Ls,L}; // compute the first sample
if pl(1,s)= Ls go to end; // exit if there is no more then one sample
i=2; while (pl(i−1,s)<=L //stopping condition is not met) {
      //take i-th sample
      A(i,s)=RandU(0,2*As);
    if (pl(i−1,s)+Fs+A(i,s)<=L) {
      pf(i,s)=pf(i−1,s)+Fs+A(i,s);
        pl(i,s)=pf(i,s)+Ls;
    } else{
      pl(i,s)=L;
      pf(i,s)=max(1,L−Ls+1);
    }//end if else
  i=i+1; // point to the next sample
}//end while
end;
```

### Algorithm 1: Sampling the Strings from the Text Block Extracted that has been Extracted for Sampling from the Email

Note that the first sample might be shorter then Ls. Reasonable values that we expect to work well for short strings are: Ls=12-16, Fs=⅔*Ls, As=⅙*Ls, and for long strings are: Ls=40-60, Fs=½*Ls, As=¼*Fs. Note that in this way the included figures are only processed via the corresponding hyperlinks text, which is a weakness that could be exploited by spammers tricks as: giving different names to the same figure in different spam copies, adding possibly long text to the hyperlink that will not be displayed to the human reader but can be used as a denial of service or miss-training attack, moving the figure at different position within the text in different spam copies, replacing different groups of letters by figures containing the same letters or putting the complete spam message into the figure.

### 5.1.6 Pre-Processing the Figures for Sampling

More sophisticated method for processing the figures would be to replace the corresponding hyperlinks, which instruct the email reading program to display the figures together with text, by textual or binary strings that extract the features from the figure in a way that preserves the similarity of figures into the similarity of the corresponding strings, and is resistant to the obfuscations by spammer that would have a goal to hide this similarity between the different spam copies.

The most simple and cheap possible solution would be to replace each figure with a single character, the character which is preferably different from letters and numbers and other often used symbols, and then process the obtained text block as if there are no figures. This would only represent the fact that there is a figure at the given position within the text, but would be more efficient and more resistant to spammers' tricks then keeping and processing the hyperlink text. Still, this would not capture the content of the figures.

One way to sample the content of the figures and capture similarity among the different obfuscated copies of the same figure would be to process the figure using a modification of a standard text recognition technique, replace the figure with the recognized text and consider this text as the part of the text block used in main sampling procedure. As the antispam system applies post-processing of the sampled strings and is resistant to the text obfuscations, it would also be resistant to the mistakes in text recognition. Though we expect that this method is useful for any figure sizes, it seems to be especially useful in the case of text obfuscated by the spammer by replacing groups of characters by small figures containing the same characters.

Another way to sample the figures would be to divide the figure into number of parts, depending on its size in pixels, and to analyzing features of each part and encode the results by text or binary strings. Concatenation of such strings would replace the figure in the text block used in the main sampling process.

Any picture pre-processing method or combination of methods are appropriate that transform the picture into the texts and preserves the similarity among the pictures in the resulting text, as the rest of the antispam system is designed to be simple and efficient on such textual input.

### 5.1.7 Email-Specific and Sampling-Position-Specific Fields are Added to the Sample.

One mail-specific field contains a random number generated for the email and added to the all samples taken from this email. It enables checking, with high probability, if two binary patterns corresponding to samples, or to danger signals, or to detectors, origin from the same email or not.

Another email specific field is a unique identifier of the email assigned to the all samples taken from this email. It can be implemented as a pointer to the email and is used to easily find the email related to detected proportional signatures.

The sampling-position-specific field is equal to the sample number, assigned in order in which the samples of given size are taken from the email. This field could be useful for combining incoming danger signals corresponding to the short samples.

### 5.1.8 Triggered, Additional Sampling

Main reason to have both main sampling, which is applied to all incoming emails, and triggered additional sampling that is turned on only in some cases, is to manage the resources of the antispam system as optimal as possible. If an email is written in plain text only, without using any formatting tricks, the main sampling is enough to efficiently represent any possible message that this text brings. This will be the case with many normal emails. But if any common variation from normal writing is found that suggests possible use of the spammers' tricks, the message is worth of additional processing. For example, if a letter is repeated to fill the space among the peaces of a phrase, that is a sign of obfuscation. Such repeated letter will easily be filtered out from the text by the reader, but could cause the filter to not capture the spammy phrase efficiently. As this concrete obfuscation will result in binary representation of some samples having fewer bits set then statistically normal, it can be easily detected by the rule that simply checks the number of bits set in the binary representation of each sample. Detection by a rule can trigger the rule specific additional sampling or general additional sampling, or both. A specific additional sampling in the example above would be repeated standard sampling on the text block but with this letter removed whenever found to be repeated. A general additional sampling would be repeated standard sampling with higher overlap for short samples aimed at capturing the expressions.

A set of such triggering rules certainly represents the innate part of the antispam system. It applies message-content nonspecific rules and results in activation of the adaptive part for additional sampling and processing. The most general innate part of our antispam system would be any other rules-based filter or even a complete Bayesian filter for example, though the last one can be viewed as an adaptive filter itself.

Other examples of rules to be part of the innate system are: many hyperlinks to web pages; many hyperlinks to the pictures to be include in the text; some letters are colored or capitalized, suggesting possible message obtained by reading only these letters; many spaces and tabs are present in the text, suggesting special meaning of the position of the letters and possible message obtained by diagonal reading, and suggesting additional specific diagonal sampling that would take the tabs and spaces into account more precisely.

### 5.2 Transforming the Strings into the Proportional Signatures

There are several reasons and goals to transform the sampled text strings into binary representation. First, in order to preserve privacy, it is important to hide the original text when exchanging the information among the antispam systems. To achieve this we use one way hash functions when transforming text string into its binary equivalent.

Second, it is important that the similarity of the strings, as it would be perceived by the reader, is kept as similarity of the corresponding binary patterns that is easy to compute and statistically confident. Similarity might mean small hamming distance, for example. Statistically confident means that the samples from unrelated emails should with very high chance have the similarity smaller than a given threshold, while the corresponding samples from the different obfuscations of the same spam email, or from similar spam emails, should with high chance have the similarity above the threshold. “Corresponding” means that they cover similar spammy patterns (expressions or phrases) that exist in the both emails.

Third, the binary representation should be efficient, i.e. it should compress the information contained in the text string and keep only what is relevant for comparing the similarity.

Last, but not least important, the binary representation should provide possibility to generate the random detectors that are difficult to be anticipated and tricked by the spammers, even if the source code of the system is known to the spammers.

To achieve the above listed goals, we design the representation based on so called similarity hashing. We use the method very similar to the one used by DCC.

The method is illustrated on the FIG. 6. A string the fixed length sampled at the random position from the email is used as the input. The sliding window is applied through the text of the string. It is moved character by character. For each position of the sliding window 8 different trigrams are identified. A trigram consists of three characters taken from the predefined window positions. Only the trigrams containing the characters in the original order from the 5-character window and not spaced more then by one character are selected. Then a parametric hash function is applied that transforms each trigram into the integer from 1 to M, where M is the size of the binary representation (typical value 1024). The bit within the binary string “proportional signature” indexed by the computed integer is set to 1. The procedure is repeated for all window positions and all trigrams. Unlike the DCC method that accumulates the results within the bins of the proportional signature, and then applies a threshold to set some of the bins to zero and other into 1, we just do overwrite if the bit is already set. So the filling of the proportional signature is the same as filling so called Bloom filters, so it represents a Bloom structure. In the used transformation, M is determined as the smallest value that provides desirable small contention in the Bloom structure. It is important to notice that the hash function could be any mapping from the trigrams on the 1-M interval, preferably with a uniform distribution of values for randomly generated text. The parameter p on the figure controls the mapping. Preferably, the hash function produce the same values for the trigrams containing the same set of characters, in order to achieve robustness against letters miss-ordering obfuscations of words.

It should be noticed that each trigram generated from the complete string by using the sliding window and generating the predefined trigrams from that window actually consists of three characters from the complete string taken at the predefined positions. Any predefined set of trigrams can be used, but preferable a trigram characters are close to each other in the complete string, and these trigrams are taken uniformly from the complete string.

It should also be noticed that use of the Bloom like structure an setting of the bits prevents from deleting some of the bits of the spammy pattern by text additions. Contrary, with a method like DCC that counts for the number of hashes that point to each signature bit, and then converts highest scores to one and the lover once to zero, it is possible to add text that will overweight the spammy phrase hashes and prevent them of being shown up in the signature.

It should also be noticed that if the size of the signature is designed for low contention when setting the bits to one in the used Bloom structure, the loss of the information is small and the similarity is better preserved, while still good compression is possible that prevents from recreating the original string; and also uses the bits efficiently. Small information loss enables the conversion of the signatures from one hash-mapping to another hash-mapping that still keeps good similarity properties, and may be for exchanging the information among different antispam systems that do not want to reveal their hash-mapping, i.e. their parameter p.

### 5.3 Using Different Representation on Collaborating Antispam Systems

The binary representation enables two modes of collaboration among the different antispam systems and different levels of randomness of the detectors. One mode assumes that all the collaborating antispam systems have the same parameter p, which is simple and computationally cheap. Such solution is more vulnerable to the getting parameter p know by the spammer, but could be safely used if the collaborating antispam systems are controlled by the same people, for example the antispam service provider people maintaining the antispam appliances for multiple organizations.

If the antispam system collaborates to other antispam systems that might get compromised by the spammer, the preferred mode is to have different p value at each antispam system. As M is designed so that the number of bits that experience the contention during the creation of a signature, the mapping exists from the signature produced using one value of p to a signature that is similar to the one produced using another value of p. Exchange of signatures with a collaborating antispam system, without reveling its own representation parameter p is possible through a Difie-Helman like algorithm to generate a third p value that will be used for the exchange of the signatures.

So each system may have and use its own parameter p randomly generated upon startup of the system, or regenerated later, which introduces an desirable randomness in the detectors on the Internet level.

### LIST OF REFERENCES

[1] E. Damiani, S. De Capitani di Vimercati, S. Paraboschi, P. Samarati, “An Open Digest-based Technique for Spam Detection,” in Proc. of the 2004 International Workshop on Security in Parallel and Distributed Systems, San Francisco, Calif. USA, Sep. 15-17, 2004
[2] DCC—Distributed Checksum Clearinghouse: http://www.rhyolite.com/anti-spam/dcc/, Sep. 1, 2006.
[3] William Cotten, U.S. Pat. No. 6,330,590.
[4] Paul Graham: A plan for spam. http://www.paulgraham.com/spam.html, Sep. 1, 2006.
[5] Terri Oda, Tony White: Developing an immunity to spam. In: Genetic and Evolutionary Computation Conference (GECCO 2003), Proceedings, Part I. Volume 2723 of Lecture Notes in Computer Science, 231-241. Chicago, 2003.
[6] Andrew Secker, Alex Freitas, Jon Timmis: “AISEC: An Artificial Immune System for Email Classification”. In Proceedings of the Congress on Evolutionary Computation, Canberra, IEEE, 131-139. Canbera, Australia, 2003.
[7] Feng Zhou, Li Zhuang, Ben Y. Zhao, Ling Huang, Anthony D. Joseph, and John D. Kubiatowicz: Approximate object location and spam filtering on peer-to-peer systems, in Proceedings of Middleware, ACM, 1-20. Rio de Janeiro, Brazil, June 2003.

1. Method to filter electronic messages in a message processing system, this message processing system comprising a temporary memory for storing the received messages intended to users, a first database dedicated to a specific recipient, and a second database dedicated to a group of recipients, this method comprising the steps of:
a) receiving an electronic message and storing it into the temporary memory,
b) generating a plurality of proportional signatures of said message, each signature being generated from a string of predefined length of the message content sampled at random location in the message content,
c) comparing with a first similarity threshold the generated signatures with the signatures present in the first database related to the message's recipient, and eliminating the generated signatures that are within the first similarity threshold of the first database's signatures, thus forming a set of suspicious signatures,
d) comparing with a second predefined similarity threshold the suspicious signatures with activated signatures present in the second database, and flagging the message as spam if at least one of the suspicious signatures is within the second predefined similarity threshold of the second database's activated signatures,
e) allowing a user to access the message, and moving said message from the temporary memory into a recipient's memory,
f) if the message is accepted by the user, storing the generated signatures related to this message into the first database related to this recipient,
g) if the message is declared spam by the user, using the suspicious signatures of said message in the second database for, either, if no similar signature exists, creating a non-activated signature into the second database with said signature or updating a previously stored signature that is within of a third similarity threshold of a suspicious signature by incrementing its first matching counter, and activating said previously stored signature if the matching counter is above a first counter threshold.

2. Method to filter electronic messages of claim 1, wherein the message processing system comprises the further steps of:
h) comparing with a fourth similarity threshold the suspicious signatures with non-activated signatures present in the second database, and if a match is found, updating a second matching counter of said non-activated signature, activating the signature if the first and second matching counters satisfy a predefined function, comparing and flagging the message as spam if the suspicious signature is within the second predefined similarity threshold of the newly activated second database's signature.

3. Method to filter electronic messages of claim 1, wherein it comprises the steps of:
when a signature stored into the second database is declared activated, all the messages currently in the temporary memory are once again processed according to the step d).

4. Method to filter electronic messages of claim 1, wherein it comprises the steps of:
defining at least one expiration field associated with each matching counter of second database's signature,
setting an expiration date in the expiration field for a new entry when it is created into the second database,
each time the matching counter is updated, the expiration field is updated with a new expiration date,
deleting the signature when the current date is after the expiration date of all expiration fields.

5. Method to filter electronic messages of claim 1, wherein the signatures stored in the second database are initially moved or updated along with an identification field of the recipient, and when a signature is activated, said signature is copied from the second database's signature into the user-specific signatures database, for each user whose identification field was associated to the activated signature, and setting the expiration date for the moved signatures, and deleting the user-specific signatures upon the date is expired

6. Method to filter electronic messages of claim 1, wherein when an activated signature is copied from the second database into a user-specific signatures database, it is stored within the user-specific signatures database only if it is out of a fifth similarity threshold of all the already existing signatures in the user-specific signatures database, otherwise it is used to update the expiration date of the first existing signature in the user-specific signatures database found to be within the fifth similarity threshold of the copied signature.

7. Method to filter electronic messages of claim 1, wherein the local message processing system comprises communication means with at least one remote message processing system, and when a user of a local message processing system declares a message spam, transmitting the suspicious signatures of said message to the second database of said remote message processing system.

8. Method to filter electronic messages of claim 1, wherein the local message processing system comprises communication means with at least one remote message processing system, sending the locally updated second database signature to the remote message processing system if the first and second matching counters satisfy a predefined function.

9. Method to filter electronic messages of claim 1, wherein it comprises a pre-processing step for authenticating the sender of the message and avoiding the processing steps b) to g) if the sender is positively authenticated and known by the recipient of the message from previous communication of the sender of non-spam messages.

10. Method to filter electronic messages of claim 1, wherein the generation of the signature from a sampled string comprises the following steps:
defining the signature as an area of bits of predefined length M, initially set to zero, the length being designed to provide a desirable low contention for using Bloom filter principle to set some of the bits to one
generating predefined number of the n-grams from the sampled string, preferably trigrams, each containing n characters taken at predefined positions from the sampled string, preferably these positions being close to each other for a n-gram
hashing each generated n-gram into the corresponding signature position
using the Bloom filter principle and so setting to one those bits of the trigram at which one or more hash values of the trigrams pointed to.
